(19) United States
(12) Patent Application Publication
(10) Pub. No.: US 2016/0232585 A1
(43) Pub. Date: Aug. 11, 2016

(54) DISTRIBUTING CONTENT

(71) Applicants: MASTERCARD INTERNATIONAL INCORPORATED, New York, NY (US); PARKEON S.A.S, Paris (FR)

(72) Inventors: Bertrand Bathelemy, Paris (FR); Davide Messina, Rome (IT); Francesco Guzzetta, Miami Beach, FL (US)

(21) Appl. No.: 15/021,068

(22) PCT Filed: Sep. 11, 2014
(86) PCT No.: PCT/EP2014/069462

§ 371 Date: Mar. 10, 2016

(30) Foreign Application Priority Data
Sep. 11, 2013 (GB) 1316199.7

(51) Int. Cl. G06Q 30/06; G06Q 30/02

(52) U.S. Cl. CPC G06Q 30/0601; G06Q 30/0269; G06Q 30/0267; G06Q 2240/00

(57) ABSTRACT

A method of distributing an offer to a user, the method being implemented on a processor, and the method comprising: receiving information associated with a plurality of offers, wherein the information associated with each offer comprises an offer identifier; providing the information associated with the offers to the user; receiving an offer selection from the user; receiving confirmation of a payment in exchange for a service; and providing the offer identifier associated with the selected offer to the user.

### TECHNICAL FIELD

The present invention relates to distributing content. More particularly, but not exclusively, to distributing content via an offer terminal. In one example, advertisements may be distributed via an offer terminal.

### BACKGROUND

Retailers, restaurants, and other service providers (hereinafter referred to as “merchants”) advertise in a variety of ways in order to reach consumers. Advertisements may include offers provided by merchants, non-limiting examples of offers including discount codes and coupons. Commonly used platforms for advertisements that comprise offers include newspapers, magazines, flyers and the Internet (e.g. email marketing and mobile applications).

Typically, email marketing and mobile applications require a lengthy registration process and the consumers are regularly issued offers. Further, offers that are issued may not be relevant to the consumer, reducing the effectiveness of the advertising platform. Alternatively, a consumer may be interested in an offer but forget about the offer during the interval between receiving the offer and arriving in the vicinity of the merchant supplying the offer.

Offers may be targeted to users based on based on a user profile, as discussed in US2013/0124283 incorporated herein by reference. For example, a specific offer may be issued to a user based on the user profile which includes the user's preference for types of offers and/or the user's location.

The present invention aims to provide consumers relevant offers in a timely manner that overcomes one or more of the problems described above.

### STATEMENTS OF INVENTION

According to an aspect of the present invention, there is provided a method of distributing an offer to a user, the method being implemented on a processor, and the method comprising: receiving information associated with a plurality of offers, wherein the information associated with each offer comprises an offer identifier; providing the information associated with the plurality of offers to the user; receiving an offer selection from the user; receiving confirmation of a payment in exchange for a service; and providing the offer identifier associated with the selected offer to the user.

Optionally, providing the information associated with the plurality of offers to the user comprises displaying the information associated with the offers.

Optionally, providing the information associated with the plurality of offers to the user comprises audibly playing the information associated with the offers.

Optionally, providing the information associated with the plurality of offers to the user comprises printing the information associated with the offers.

Optionally, providing the offer identifier comprises printing a ticket comprising the offer identifier. Optionally, the offer identifier is printed in the form of at least one from a group comprising: an alphanumeric string; a barcode; and a quick response code.

Optionally, if the user comprises a mobile device, providing the offer identifier comprises sending an electronic communication to the mobile device, wherein the electronic communication is at least one from a group including: an email; an SMS; a near field communication instruction; a Bluetooth message; a communication over a Wi-Fi network; and an instant message.

Optionally, the user comprises a payment transaction device, and providing the offer identifier comprises associating an account of the payment transaction device with the offer identifier.

Optionally, the method comprises determining a set of offers from the plurality of offers and wherein providing the information associated with the offers to the user comprises providing the set to the user.

Optionally, the method comprises sending the selected offer to a remote server.

Optionally, the information associated with the offer comprises one or more from a group comprising: an offer number; an offer type; an offer description; terms and conditions of validity; a location where the offer is redeemable; a name of a merchant providing the offer; and a category.

Optionally, the payment is in exchange for parking services.

Optionally, the method comprises providing a receipt for the payment to the user.

A non-transitory computer-readable storage medium may store executable computer program instructions for implementing on a computing device the method described above.

According to an aspect of the present invention, there is provided an offer terminal for distributing an offer to a user arranged to: receive information associated with a plurality of offers, wherein the information associated with each offer comprises an offer identifier; provide the information associated with the plurality of offers to the user; receive an offer selection from the user; receive confirmation of a payment in exchange for a service; and provide the offer identifier associated with the selected offer to the user.

It will be appreciated that preferred and/or optional features of the first aspect of the invention may be provided in the second aspect of the invention also, either alone or in appropriate combinations.

### BRIEF DESCRIPTION OF THE DRAWINGS

In order that the invention may be more readily understood, reference will now be made, by way of example, to the accompanying drawings in which:

FIG. 1 shows an example environment according to an embodiment of the present invention;

FIG. 2 shows a schematic view of an offer terminal of FIG. 1;

FIG. 3 shows a schematic view of a terminal server of FIG. 1;

FIG. 4 shows a schematic view of a terminal database of FIG. 3;

FIG. 5 shows a schematic view of an offer server of FIG. 1;

FIG. 6 shows a schematic view of an offer database of FIG. 5;

FIG. 7 shows a schematic view of a user profile database of FIG. 5; and

FIG. 8 shows a flowchart according to an embodiment of the present invention.

### DETAILED DESCRIPTION OF SPECIFIC EMBODIMENTS

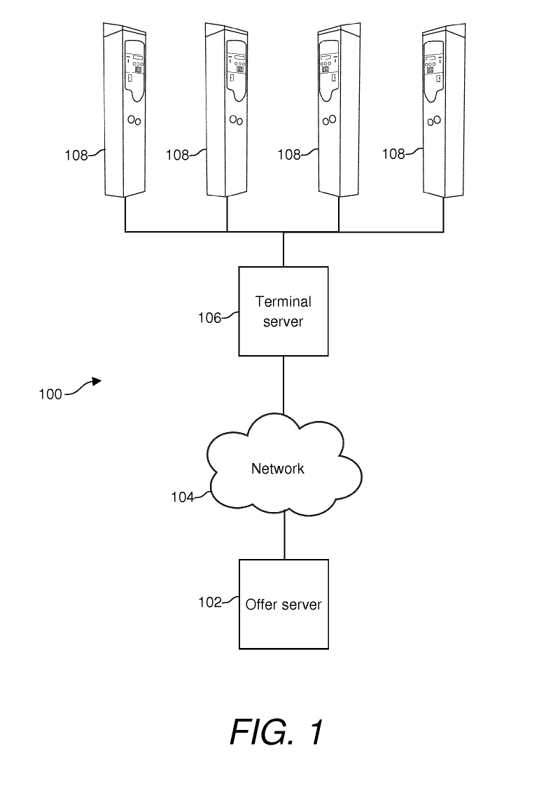

FIG. 1 shows an example environment 100 according to an embodiment of the present invention. An offer server 102 is connected to a network 104. The network 104 may be a wide area network, local area network, the Internet or other suitable data communications networks. A terminal server 106 is also connected to the network 104 such that it can communicate with the offer server 102.

Four terminals 108 are each connected to the terminal server 106. In other embodiments, each terminal 108 is connected to the network 104 and the terminal server 106 can communicate with each terminal 108 via the network 104.

The offer server 102 manages information associated with offers that merchants have made available. The terminal server 106 controls data requests to and from each terminal 108.

In this embodiment, the terminals 108 are parking payment terminal each installed at a fixed location. Merchants are generally located on shopping streets where parking vehicles on the shopping street, adjacent streets or in nearby car parks, is regulated using pay and display as is known in the art, wherein a motorist purchases a ticket from one of the plurality of parking payment terminals and displays the ticket on the dashboard or windscreen of their vehicle. Accordingly, the plurality of parking payment terminals are located on the shopping street, adjacent streets or in nearby car parks, and are configured to vend tickets for “pay and display”.

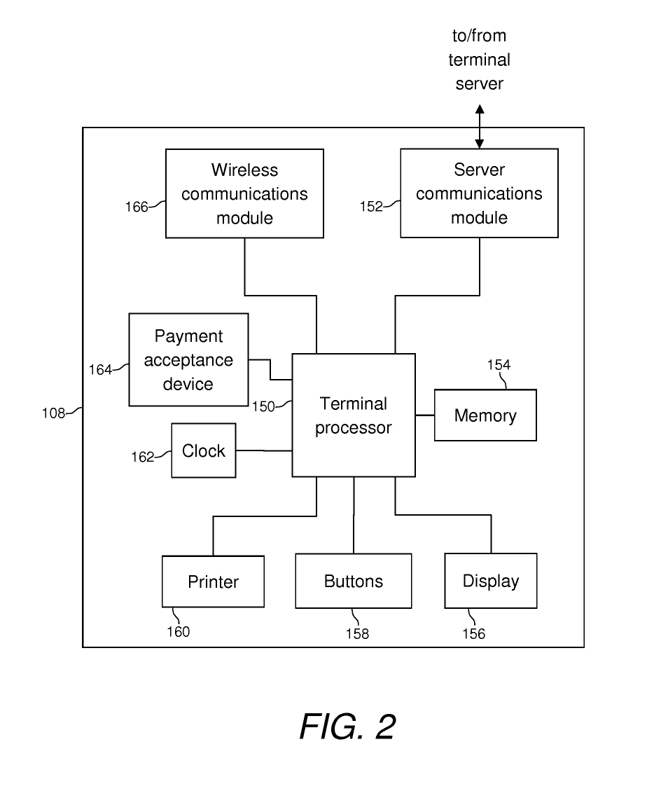

FIG. 2 shows the terminal 108 in greater detail. Each terminal 108 comprises a terminal processor 150, a server communications module 152, a memory 154, a display 156 (i.e. a screen), a plurality of user input buttons 158, a printer 160, a clock 162, a payment acceptance device 164 and a wireless communications module 166. The server communications module 152, the memory 154, the display 156, the plurality of user input buttons 158, the printer 160, the clock 162, the payment acceptance device 164 and the wireless communications module 166 are each connected to the terminal processor 150.

The server communications module 152 is arranged to communicate data to and from the terminal server 106. The memory 154 is arranged to store data, including information associated with an offer (i.e. offer details), as well as an terminal identity number.

The display 156 and user input buttons 158 provide an interface for a user to interact with the terminal. In other embodiments the display and input buttons are combined in one device, such as a touchscreen.

The printer 160 is arranged to output a ticket for the user as a receipt for payment of parking. The printer 160 in this embodiment is a thermal printer. The clock 162 measures time.

The payment acceptance device 164 is arranged to accept cash and contact/contactless integrated circuit cards to enable users to pay for parking at the terminal 108.

The wireless communications module 166 may comprise 3G, 4G LTE, Wi-Fi, Bluetooth® or near field communication (NFC) technology for communicating with a mobile device of a user.

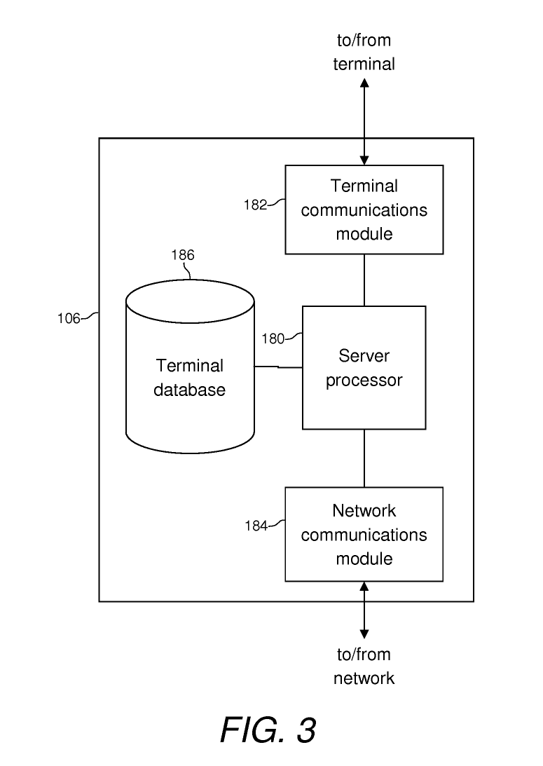

FIG. 3 shows the terminal server 106 in greater detail. The terminal server 106 comprises a server processor 180, a terminal communications module 182, a network communications module 184 and a terminal database 186. The terminal communications module 182, the network communications module 184 and the terminal database 186 are each connected to the server processor 180.

The terminal communications module 182 is configured to communicate with each of the terminals 108. The network communications module 184 is configured to communicate data to and from the network 104.

The terminal database 186 comprises data associated with each of the terminals 108.

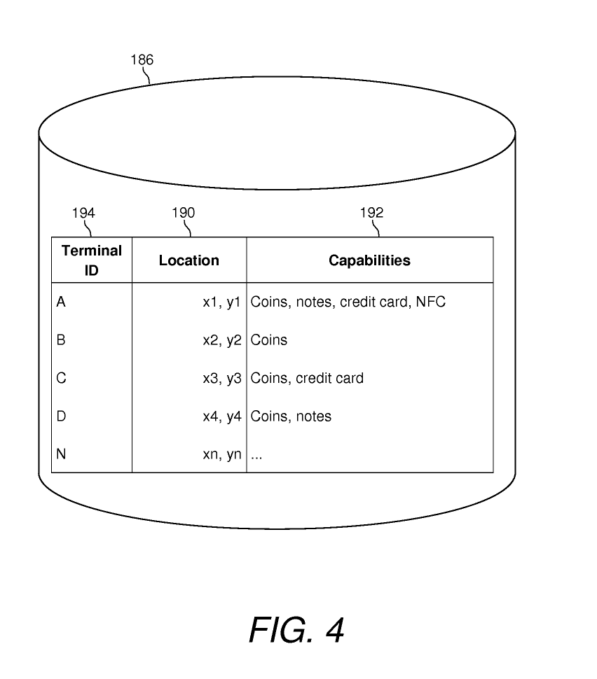

FIG. 4 shows the terminal database 186 in greater detail. The terminal database 186 comprises a location 190 and capabilities 192 of each terminal 108 associated with a terminal identity number 194. The location 190 may be an address, latitude and longitude coordinates or a grid reference. The capabilities 192 may be related to the type of payment acceptance device 164 that each terminal 108 comprises, for example, coin acceptance, bank note acceptance, credit card acceptance or contactless card acceptance.

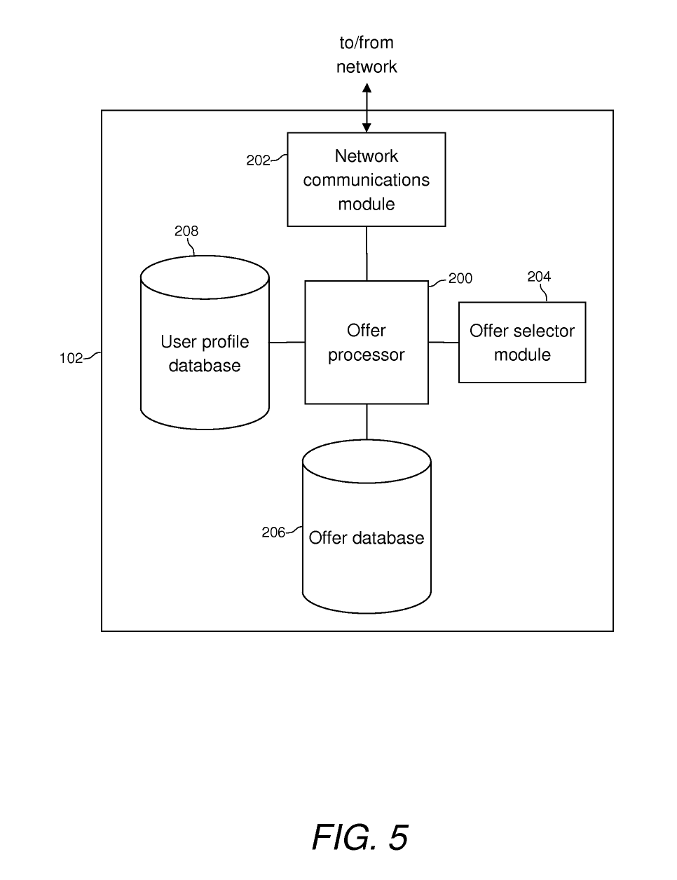

FIG. 5 shows the offer server 102 in greater detail. The offer server 102 comprises an offer processor 200, a network communications module 202, an offer selector module 204, an offer database 206 and a user profile database 208. The network communications module 202, the offer selector module 204, the offer database 206 and the user profile database 208 are each connected to the offer processor 200.

The network communications module 202 is configured to communicate data to and from the network 104. The offer database 206 comprises information associated with offers. The user profile database 208 comprises information associated with both the terminals 108 and the users of the terminals.

The offer selector module 204 is arranged to determine offers to be sent to the terminals 108 based on the information associated with the offers from the offer database 206 and data from the user profile database 208.

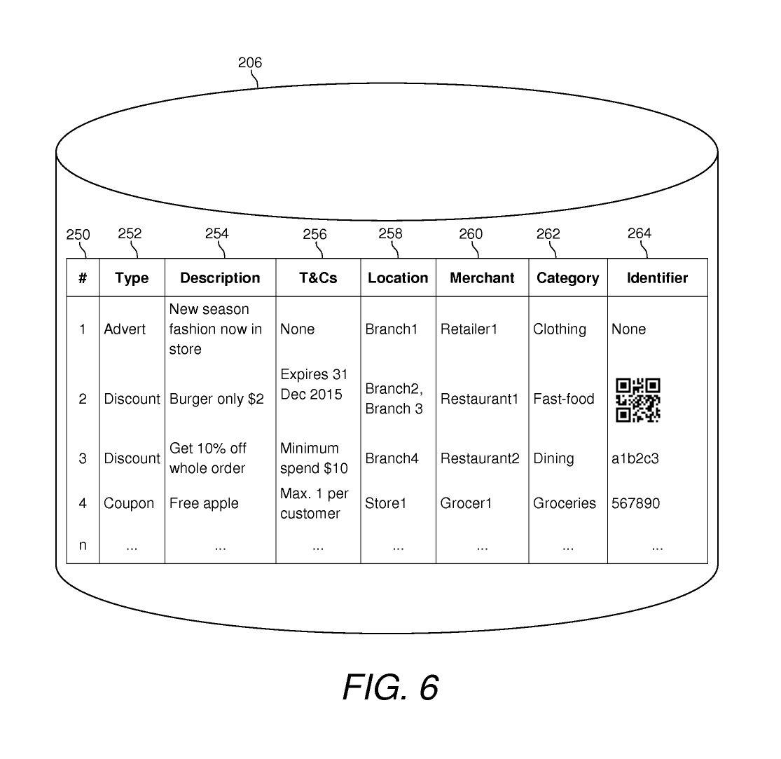

FIG. 6 shows the offer database 206 in greater detail. The offer database 206 comprises, for each offer, an offer number 250, an offer type 252, an offer description 254, terms and conditions of validity 256, a location 258 where the offer is redeemable, a merchant name 260, a category 262 and an offer identifier 264.

Merchants place details of offers into the offer database 206 which is administered by an offer administrator that controls the offer server 102. The type 252 of an offer may be the purchase of goods or services, an advertisement for a product or service, or an offer for purchasing the goods or services at a discount (e.g. a coupon).

The offer description 254 may comprise marketing copy that explains the offer, and may include images.

The terms and conditions 256 of an offer may include time-sensitivity, such as a bakery offering its goods at a discount until closing time in an effort to sell inventory it would otherwise dispose of, for instance. Further, terms and conditions 256 may also be restricted to a specific number of redemptions, such as an offer for a discount or a free item for the first one hundred people to arrive at the store.

Offers may also be associated with a particular merchant, stored in the offer database 206 as the merchant name 260 of the offer. The location 258 of the offer may comprise, for example, addresses of a plurality of shops of the merchant at which the offer is redeemable.

The category 262 of an offer is the category of goods or services that the offer relates to (e.g. fast-food, grocery store, parking, clothing etc.).

The offer identifier 264 may be an alphanumeric code, barcode, quick response (QR) code or other an optical machine-readable representation of data that may be used to redeem the offer with the merchant providing the offer.

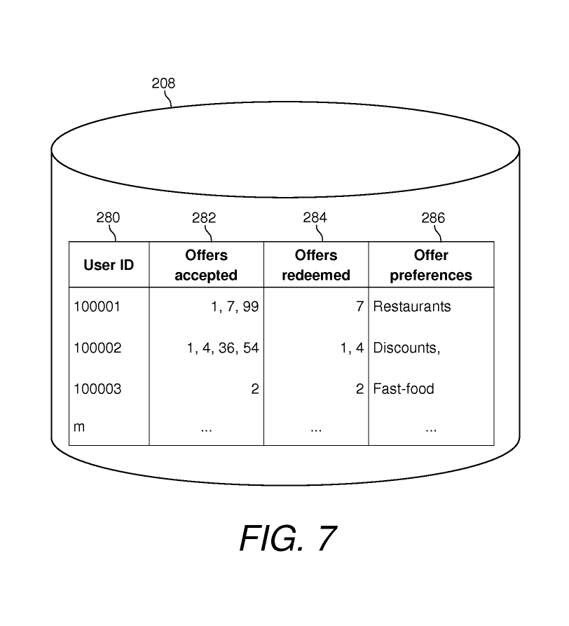

FIG. 7 shows the user profile database 208 in greater detail. The user profile database 208 comprises a user identity 280 for each user. Offers accepted 282, offers redeemed 284 and offer preferences 286 for each user are stored in the user profile database 208. The offers accepted 282 are the offers (stored with reference to the offer numbers 250) that each user has selected as of interest to them. The offers redeemed 284 are the offers (stored with reference to the offer numbers 250) that each user has redeemed at the merchant using the offer identifier 264.

The offer preferences 286 relate to the type 252 and category 262 of offers that are selected by a user. Offer preference 286 may also comprise a geographical area in which a user is likely to redeem offers in.

The offer preferences 286 can be defined manually by a user or determined by the offer processor 200 based on the predominant type 252 and category 262 of offers accepted by a user, and typical locations where offers are redeemed.

According to an embodiment of the present invention, in addition to vending tickets for pay and display, the parking payment terminal 108 is configured to dispense offers. The parking payment terminal may be used by motorist as well as other pedestrians to request offers.

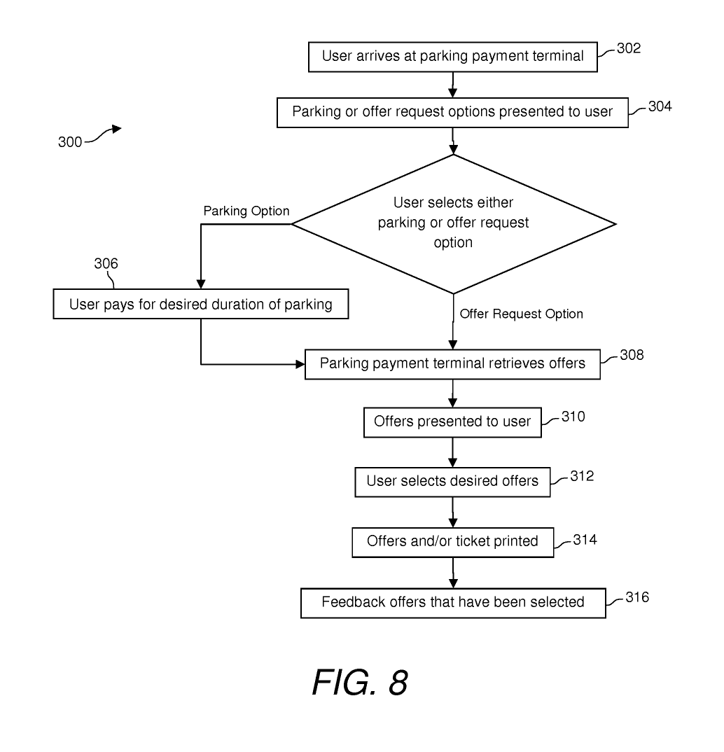

FIG. 8 shows a flowchart providing an overview of a process 300 according to an embodiment of the present invention.

When a user arrives at Step 302 at a terminal 108, the terminal initially displays at Step 304 two options to a user via the screen 156: a first option to pay for parking and a second option to request an offer. If the user opts to pay for parking, the user indicates the desired duration of the parking session and the parking payment terminal 108 charges the user for the parking session. The user pays at Step 306 for the parking session using the payment acceptance device 164. In other embodiments, Step 306 occurs immediately after the user arrives at the parking payment terminal 108, (in other words, the user is not initially presented with the first option to pay for parking or the second option to request an offer).

Once the user has completed payment for the parking session, or if the user selected the offer request option, the parking payment terminal retrieves at Step 308 offer details from the offer server 102. The process of retrieving offer details is discussed below in more detail. The retrieved offers are presented at Step 310 to the user via the screen 156. This may be in the form of a list of offers or the offers may be divided into menus according to categories and/or merchants. The clock 162 of the parking payment terminal 108 is used to determine the time and offers appropriate for the time of day are given more prominence on the screen 156 (e.g. offers from restaurants and cafes at lunch time, shops in the afternoon and clubs and cinemas in the evening).

The user selects at Step 312 any desired offers from the retrieved offers. Following this, the parking payment terminal prints at Step 314 the ticket and/or the offer identifier 264 along with other details of any selected offers using the printer 160. In other embodiments, the parking payment terminal 108 provides the details of any selected offers to a mobile device of the user using the wireless communications module 166.

In other embodiments, one offer is automatically retrieved and printed at Step 314 in conjunction with the parking ticket once the user has completed payment for the parking session.

If an offer is selected, the parking payment terminal 108 records in the memory 154 that the offer has been selected. The recorded information may be communicated at Step 316 to the offer server periodically or immediately after an offer is selected.

As users of the terminal 108 are not required to register with the offer server, the terminal 108 is a user with respect to the user profile database 208. The record of the offers that have been selected is used to determine preferred offers for each parking payment terminal, for example, if several users of the terminal 108 all select an offer provided by a particular merchant, other offers from that particular merchant may be given prominence when the offers are displayed to future users of that parking payment terminal 108.

In other embodiments, a user comprises a payment transaction device (such as a credit card) that is associated with a user identity 280 in the user profile database 208. Accordingly, if a user accepts an offer, the offer identifier 264 is associated with an account of the transaction device. The user can then purchase the goods or services on offer at the merchant using the transaction device with which the offer is associated such that the offer is applied to the transaction.

Examples of different ways in which the offers are retrieved by the terminal 108 are described below, however, it is to be understood that embodiments of the invention may comprise one or more of the examples simultaneously.

In a first example, the parking payment terminal 108 periodically receives updated offer details from the offer database 206 via the offer server 102 and the terminal server 106, and stores them in the memory 154. The offer details supplied to the parking payment terminal 108 may be restricted to offers from merchants within a predetermined range (e.g. within a 2 kilometre radius) of the parking payment terminal 108, reducing the bandwidth required to communicate the offer details when compared to supplying all offer details. In this example, the process of retrieving offers comprises the parking payment terminal 108 accessing the memory 154 to find offers and the clock 162 of the parking payment terminal 108 being used to determine the time to find offers that are appropriate for the time of the day. A benefit of this example is that relevant offer details of nearby merchants can be quickly accessed by the parking payment terminal when required as the offer details are stored locally.

In a second example, the parking payment terminal 108 retrieves offer details from the offers database 206 on demand. The parking payment terminal 108 sends a communication to request offer details to the offer server 102 comprising the location and the identity number of the parking payment terminal 108 and the time of day. The offer selector module 204 of the offer server 102 queries the offer database 206 and user profile database 208 for offer details that are suitable for the time of day and are within a predetermined range (e.g. within a 2 kilometre radius) of the parking payment terminal 108. The resulting offer details that match the query are returned to the parking payment terminal 108 for display to the user. A benefit of this example is that relevant offer details are returned to the parking payment terminal, reducing the bandwidth required to communicate the offer details. Further, this reduces the storage required on the parking payment terminal 108, compared to the first example.

In other embodiments of the second example, the offer server 102 uses the identity number of the parking payment terminal to identify the offers that have been selected by previous users of the parking payment terminal (i.e. with reference to the user profile database 208). The offer server 102 then determines a set of offers that are likely to be accepted by the user and returns the offer details corresponding to the group of offers to the parking payment terminal 108 for display to the user.

In a third example, the user pays for the desired duration of parking with an integrated circuit chip card where a unique number is assigned to the card by an issuer of the card. The parking payment terminal 108 sends a communication to request offer details to the offer server 102 comprising the location of the parking payment terminal, the time of day and the unique number of the card. The offer server 102 queries the offer database 206 for offer details that are suitable for the time of day and are within a predetermined range (e.g. within a 2 kilometre radius) of the parking payment terminal 108. Further, the offer selector module 204 uses the unique number to identify the offers that have previously been selected by a cardholder of the card with reference to the user profile database 208. The offer selector module 204 then determines a set of offers that are likely to be accepted by the cardholder and returns the offer details corresponding to the group of offers to the parking payment terminal for display to the cardholder.

In other embodiments of the third example, the integrated circuit chip card is a contactless card (e.g. using near field communications standards). Once the cardholder has selected their desired offers, the offer identifiers 264 are communicated to the contactless card allowing the cardholder to redeem the offer without a printed code.

In other embodiments of the third example, the user has an online profile associated with the unique number of the card and the server uses the online profile to select personalised offers (e.g. based on offers previously accepted by the user and/or personal preferences indicated by the user on the online profile). The online profile may comprise information from social media. The offer server 102 then sends the relevant personalised offers to the parking payment terminal 108 for display to the user.

Many modifications may be made to the above examples without departing from the scope of the present invention as defined in the accompanying claims.

For example, in the process 300, following payment by the user for the parking session in Step 308, the terminal 108 may provide all available offers (including offer details and offer identifiers) to a mobile device of the user via the wireless communications module 166. The user can then select the desired offers at their leisure directly from the mobile device, and receive the offer identifier.

What is claimed is:

1. A method of distributing an offer to a user, the method being implemented on a processor, and the method comprising:
receiving information associated with a plurality of offers, wherein the information associated with each offer comprises an offer identifier;
providing the information associated with the plurality of offers to the user;
receiving an offer selection from the user;
receiving confirmation of a payment in exchange for a service; and
providing the offer identifier associated with the selected offer to the user.

2. The method of claim 1, wherein providing the information associated with the plurality of offers to the user comprises displaying the information associated with the offers.

3. The method of claim 1, wherein providing the information associated with the plurality of offers to the user comprises audibly playing the information associated with the offers.

4. The method of claim 1, wherein providing the information associated with the plurality of offers to the user comprises printing the information associated with the offers.

5. The method of claim 1, wherein providing the offer identifier comprises printing a ticket comprising the offer identifier.

6. The method of claim 5, wherein the offer identifier is printed in a form comprising at least one of:
an alphanumeric string;
a barcode; and
a quick response code.

7. The method of claim 1, wherein the user comprises a mobile device, and providing the offer identifier comprises sending an electronic communication to the mobile device, wherein the electronic communication is at least one from a group including: an email; an SMS; a near field communication instruction; a Bluetooth message; a communication over a Wi-Fi network; and an instant message.

8. The method of claim 1, wherein the user comprises a payment transaction device, and providing the offer identifier comprises associating an account of the payment transaction device with the offer identifier.

9. The method of claim 1, comprising determining a set of offers from the plurality of offers and wherein providing the information associated with the offers to the user comprises providing the set to the user.

10. The method of claim 1, comprising sending the selected offer to a remote server.

11. The method of claim 1, wherein the information associated with the offer comprises one or more from a group comprising: an offer number; an offer type; an offer description; terms and conditions of validity; a location where the offer is redeemable;
a name of a merchant providing the offer; and a category.

12. The method of claim 1, wherein the payment is in exchange for parking services.

13. The method of claim 1, comprising providing a receipt for the payment to the user.

14. A non-transitory computer readable medium comprising computer executable instructions which when executed by a computer cause the computer to perform a method of distributing an offer to a user, said method comprising:
receiving information associated with a plurality of offers, wherein the information associated with each offer comprises an offer identifier;
providing the information associated with the plurality of offers to the user;
receiving an offer selection from the user;
receiving confirmation of a payment in exchange for a service; and
providing the offer identifier associated with the selected offer to the user.

15. An offer terminal for distributing an offer to a user, said offer terminal comprising:
a memory; and
at least one processor, coupled to said memory, and operative to:
receive information associated with a plurality of offers, wherein the information associated with each offer comprises an offer identifier;
provide the information associated with the plurality of offers to the user;
receive an offer selection from the user;
receive confirmation of a payment in exchange for a service; and
provide the offer identifier associated with the selected offer to the user.
